(19) United States
(12) Patent Application Publication
(10) Pub. No.: US 2020/0302933 A1
(43) Pub. Date: Sep. 24, 2020

(54) GENERATION OF AUDIO STORIES FROM TEXT-BASED MEDIA

(71) Applicant: Audicle Inc., Orange, CA (US)

(72) Inventors: Michael Arciero, Orange, CA (US); Ben Shand Farber, Napa, CA (US); Richard Luong Foreman, Folsom, CA (US)

(21) Appl. No.: 16/827,480

(22) Filed: Mar. 23, 2020

Related U.S. Application Data
(60) Provisional application No. 62/822,716, filed on Mar. 22, 2019.
(60) Provisional application No. 62/939,535, filed on Nov. 22, 2019.

(51) Int. Cl. G10L 15/26; G06F 40/289; G06Q 30/02; H04L 29/06

(52) U.S. Cl. CPC G10L 15/26; G06F 40/289; G06Q 30/0276; H04L 63/10; G06Q 30/0269; G06Q 30/0205; G06Q 30/0255

(57) ABSTRACT

The present embodiments relate to creating an audio story based on text-based media. An audio story can include an audio representation of the text-based media. The audio representation of the text-based media can be modified to incorporate supplemental media content at a series of time positions of the audio representation to generate the audio file. The audio story can be played back on a client device. The audio story can output along with the text-based media on an application executing on the client device. Authors of text-based media and audio stories can create/edit/publish text-based media and/or audio stories on an authoring interface.

### CROSS-REFERENCE TO RELATED APPLICATIONS

This application claims priority to U.S. Provisional Patent Application No. 62/822,716, titled “CONVERTING TEXT-BASED MEDIA INTO AUDIO STORIES,” and filed Mar. 22, 2019, and U.S. Provisional Patent Application No. 62/939,535, titled “GENERATION OF USER-SPECIFIC AUDIO STORIES,” and filed Nov. 22, 2019, which are incorporated by reference herein by their entirety.

### TECHNICAL FIELD

The disclosed teachings generally relate to audio media. The disclosed teachings more particularly relate to converting a text-based medium into an audio output.

### BACKGROUND

People consume information to understand more about the world around them. For example, people may consume information by watching a news broadcast on a television or listening to a radio broadcast. This information may provide educational insight or simply provide entertainment.

Information channels quickly gaining popularity are internet-accessible webpages that include text-based media (e.g., articles, publications). These internet-accessible webpages (hereinafter “webpages”) allow users to interact with a network-enabled electronic device (e.g., smartphone, tablet, computers) to access and read articles on the webpage. In addition, these webpages may provide a wide variety of articles directly to the user in real-time. Accordingly, users accessing these webpages can consume a vast amount of text-based information by reading the articles on an electronic device.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 illustrates a flowchart of an example method generate an audio story.

FIG. 2 is an example block diagram of a network environment in which the present embodiments can be implemented.

FIG. 3 is an example interface for outputting an audio story.

FIG. 4A illustrates a first example interface for authoring or editing aspects of an audio story.

FIG. 4B illustrates a second example interface for authoring or editing aspects of an audio story.

FIG. 5 is an example block diagram for generating a user-specific audio story.

FIG. 6 is a block diagram of an example illustration for generating a user-specific audio story.

FIG. 7 is a block diagram of an example timeline for addition of text media to an audio story.

FIG. 8 is an example flow process for onboarding an author.

FIG. 9 is a block diagram of an example illustration for generating a user-specific audio story with user-specific advertisements.

FIG. 10 is an example interface illustrating a series of articles with icons to output an audio story.

FIG. 11 is a block diagram of an example method for generating an audio story.

FIG. 12 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

A popular channel of accessing information is by reading text-based media (e.g., articles, publications) on internet-accessible webpages (or simply “webpages”). To access a webpage, users can interact with a network-enabled device (e.g., smartphone, tablet, computers) and accordingly, the user can read various articles and publications available on the webpage.

However, with the increased demand of reading articles on these webpages, there also can be an increase in the number or articles read by the user and the amount of information consumed. Particularly with text-based media, the user may fail to retain all of this information.

In contrast, information provided in an audio format may increase the ability of a user to retain the information conveyed via audio, as opposed to just simply text. For example, listening to an audio-based reading of a news article may result in higher retention in the information than reading the text of the news article. Accordingly, audio information may provide a greater user experience as well as entertainment to a user.

One way to provide an audio version of text is to convert the text into speech. The speech may include a computer-generated voice or recorded speech of a voice actor. However, simply converting text into speech may inadequately capture compelling features of the text. For example, an uplifting news article simply converted into speech of a computer-generated voice may inadequately portray the uplifting portions of the uplifting news article. This may result in lower user experience and may lessen engagement with the media.

Accordingly, the present embodiments relate to generating an audio story based on text-based media. Text media (e.g., news article, publication) can be converted into an audio media (e.g., speech). Further, the converted audio may be edited to include supplemental information, such as sound effects, music, video, etc. The converted audio and the supplemental information together may form the audio story. The audio story may include an increased user experience as well as higher user retention of the information conveyed in the audio story.

### Audio Story Generation Overview

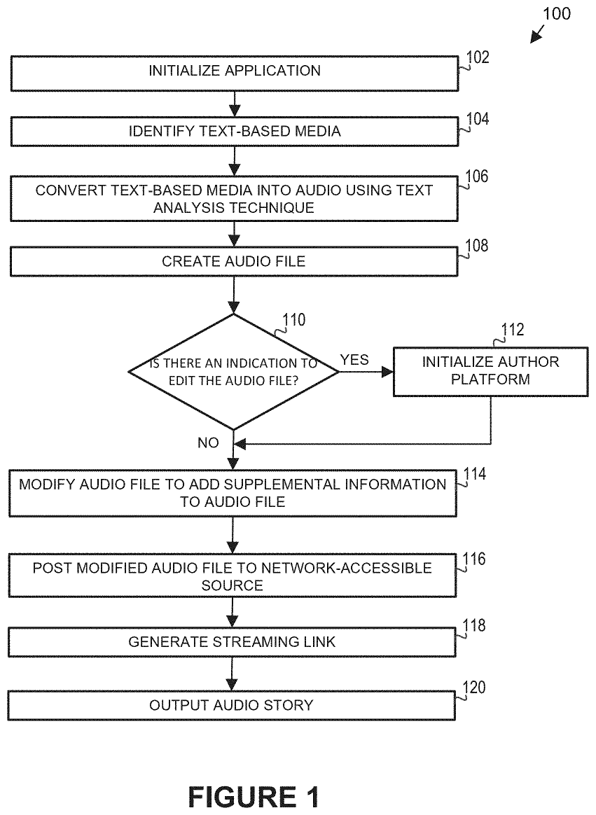

FIG. 1 illustrates a flowchart of an example method 100 generate an audio story. Generally, an audio story can include speech converted from a text-based media as well as supplemental information (e.g., music, sounds, etc.) added to the converted speech.

The method can include initializing an application (block 102). An application can execute on a client device (e.g., a smartphone). Upon launching the application on the device, a text file can be uploaded. For example, the text file can be a news article published on a news organization's webpage.

The method may include identifying a text article (block 104). The audio story may be initialized based on a selection of text to be converted into an audio story. Examples of a text article may include a news article, publication, website text, blog post, etc. In some embodiments, the text-based media may include a book (e.g., a children's book). In these embodiments, an audio story as described in the present embodiments may be generated based on the text of the book.

As noted below, identifying a text article may be based on author, article type, user preference, etc. In some embodiments, a text article may be identified based on a selection/indication provided by a user. The selection may be provided via a user device (e.g., mobile phone, tablet, computer, wearable electronic device, etc.).

The text in the text article may be converted into speech (block 106) using a text analysis technique. The text can be converted into speech using text to speech (TTS) conversion. TTS can include analyzing the text, comparing the identified text with audio in a repository or database, and generating a stream of audio information that represents an audio version of the text. For example, the converted audio may be in the form of speech, where the speech reads the words of the text in an appropriate language. The speech may be generated based on either a pre-recorded voice of a user or a computer-generated voice. Further, the speech may be in any number of languages or accents.

In some embodiments, the conversion of the text into audio can be implemented in association with machine learning, artificial intelligence, a neural network, etc. In other embodiments, artificial intelligence may be utilized to learn new languages, words, accents, text, audio, etc. to increase the quality of the converted audio. The text analysis technique can include any of keyword detection, pattern recognition, artificial intelligence, machine learning, etc.

Converting the text to speech can include parsing the text to identify words, phrases, characters, features, and other characteristics of the text. For example, a type of article may be derived from the parsed text. As another example, a tone set in the article may be derived from the parsed text.

The method can include creating an audio file (block 108). This can include generating an audio file of the speech converted from the text. The audio file can be utilized to generate an audio story. As described in greater detail below, in some embodiments, the audio file can be utilized in generating audio stories that are curated specific to a user.

The method can include determining whether there is an indication to edit the audio file (block 110). If there is an indication to edit the audio file, the method can include initializing an author platform (block 112). The author platform can allow for editing of the audio file to add other non-text media to the audio file. The author platform is described in greater detail below.

The process to generate an audio story may include modifying the audio file to add supplemental information to the audio file (block 114). This can include adding other audio media (e.g., sounds, music, effects) to portions of the audio file. The modified audio file that includes supplemental information can comprise the audio story.

As described in greater detail below, the music and sounds may be selected and added to the audio story based on characteristics of the text article and additional text-based media. Further, the selection of music or sounds may be based on information relating to the user in generating a user-specific audio story, as discussed below.

In some embodiments, the non-text media may include any of video, modifications to a virtual reality/augmented reality output, etc. In some embodiments, background video or images can play in connection with the audio.

In some embodiments, aspects of a user device can be modified as part of the audio story. For example, the brightness of a mobile phone can be modified based on the audio story. In some embodiments, network devices (e.g., internet of things (IoT)-based devices) can perform various tasks that modify the environment surrounding the user. For example, IoT-based lights can dim based on a detected tone of the audio story.

In some embodiments, adding supplemental information to the audio file may include identifying other text-based information (e.g., news articles, social media posts) that relate to the text article. For example, a social media post of a key character in a news article may be identified as being relevant to the text article and included in an audio story. As noted below, the addition of additional text-based media can be ongoing and dynamic, allowing the original text article to be updated as new information is provided and identified. The additional text-based media may be converted into speech.

The converted speech from the text article and the additional text-based media may be combined to form the audio story. This may include parsing elements of the converted speech to supplement the additional text-based media into the text article. This may also include adding additional language to appropriately transition between the text article and the additional text-based media.

The method can include posting the modified audio story to a network-accessible source (block 116). Example network-accessible sources can include a webpage, application, podcast application, music repository, etc. For example, the audio story can be uploaded onto a cloud-accessible repository of podcasts accessible by a device connected to the internet.

The method can include generating a streaming link (block 118). A streaming link may be generated linking to the generated audio story, and a user can access the audio story by clicking the link. In an embodiment, users with limited sight may listen to the audio story.

The method may include outputting the audio story (block 120). This may include sending the audio story to a user device. The audio story may be output on an audio component (e.g., headphones, speaker) of a user device.

### Environment Overview

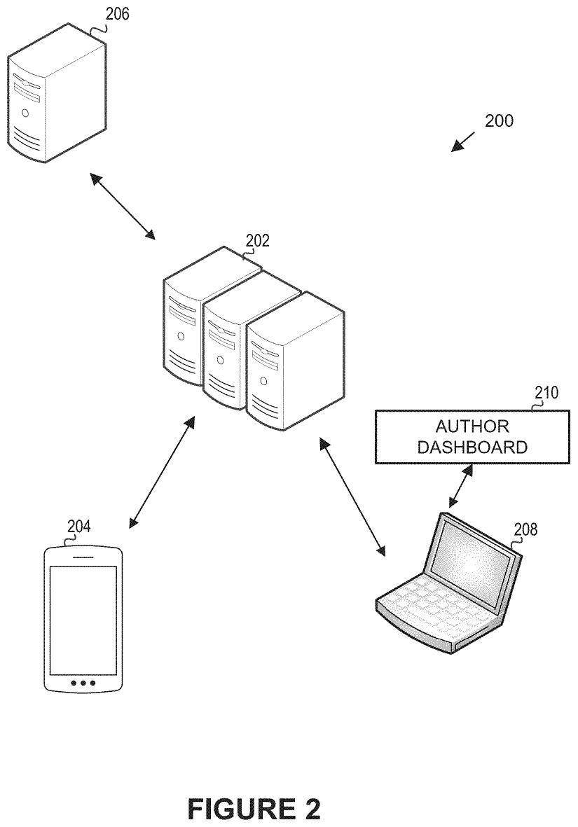

FIG. 2 is an example block diagram of a network environment 200 in which the present embodiments can be implemented. As shown in FIG. 2, the environment 200 can include any of a network-accessible server system 202, a client device 204, an external node 206, an author device 208 implementing an author dashboard 210, etc.

The network-accessible server system 202 can include one or more interconnected computing devices configured to perform various processing tasks as described herein. The network-accessible server system 202 can interact with devices in the environment 200 via a network.

The network(s) can include personal area networks (PANs), local area networks (LANs), wide area networks (WANs), metropolitan area networks (MANs), cellular networks, the Internet, etc. Additionally, or alternatively, the network-accessible server system 202 can be communicatively coupled to electronic device(s) over a short-range communication protocol, such as Bluetooth® or Near Field Communication (NFC).

The network-accessible server system 202 can communicate with a client device 204. The client device 204 can include an electronic device (e.g., smartphone, tablet, computer, wearable device) associated with a client. For instance, the client device 204 can execute an application to generate an audio story and output the audio story on the client device. Clients may receive audio stories on an application running on a network-enabled device. An application may increase the reader/listeners experience, provide reader/listeners features, and/or store reader/listeners statistics.

The environment 200 can include an external node 206 capable of providing information to the network-accessible server system 202 via a network (e.g., the internet). For instance, the external node 206 can provide text-based media (e.g., a news article) to the network-accessible server system 202 via the internet.

The environment 200 can include an author device 208. The author device 208 can include a device (e.g., computer) for editing or authoring content to be included in an audio story. For example, an author can curate text-based media (e.g., a news article), speech that can be used in the audio story, adding supplemental information or editing the audio story, etc. The author can modify audio stories using an author dashboard 210. The audio stories can be generated and edited by various creators, such as Journalists, Editors of Publications, Columnists, Reporters, Writers, Free Writers, etc.

### Audio Story Application Overview

As noted above, a client device can execute an application that can allow for output of audio stories on the client device. In some instances, the client device can display a webpage or plugin executed by an external node (e.g., network-accessible server system 202, external node 206) capable of displaying content and outputting audio stories on the client device.

An application can include one or more text-based articles. Upon selecting an article, the user can read the article on the application. The user also can click on an audio story generation button to generate an audio story of that article. A user can activate an audio story by registering with the application and activating a text-based medium to receive an audio story. Registering can include providing credentials or personal information relating to the user.

In some embodiments, the user can provide information relating to an article preference for a type of information they prefer. In terms of article preferences, the user may provide information on the type of articles or text to speech preferences the user desires. Additionally, the user may be provided a checkbox list of articles, documents by type for instance scholarly articles. Once registered, the user may be provided instructions via text, video, etc. In the registration process, the user may provide their Name, email, and other pertinent information to ensuring the application provides the best experience.

To activate an audio story, the user may press on a selection button on the app or input an indication on the application and receive an audio story.

On every news article or text which the user chooses to have application available, the user may see an icon, and, in turn, the user may activate the application. By pressing, clicking, etc., the user experience begins at the beginning of the article. The user experience may be preset and determined by the author of the article using the following audio and video preferences.

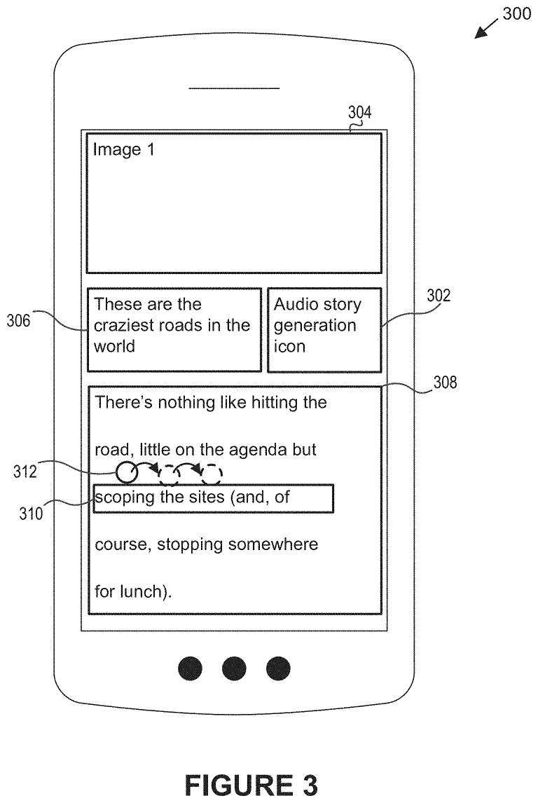

FIG. 3 is an example interface 300 for outputting an audio story. For instance, in the embodiment as shown in FIG. 3, an interface 300 can provide information relating to the text-based media that was converted into the audio story while outputting the audio story on audio components (e.g., a speaker) of the client device.

As shown in FIG. 3, the interface 300 can include an audio story generation icon 302. The user can select the icon 302 to initiate generation of an audio story. The interface 300 can also include various aspects of the text-based media that corresponds to the audio story. The interface can include an image 304 relating to the text-based media. In some instances, the image 304 can include one or more images or a video depicting various images relating to the text.

The interface 300 can include a title 306 and text 308 of the text-based media. As the audio story is outputting, the corresponding text being outputted in the audio story can be highlighted. For instance, a highlight 310 can mark or otherwise indicate words that correspond to the speech of the audio story. The interface 300 can include an icon 312 (e.g., a ball) that indicates the words that correspond to the audio story. For example, a ball 312 may follow each word across the interface 300 in a cadence that matches the output of the audio story.

In some embodiments, the application can include options to share the audio story, provide feedback (“like” or “dislike”) to the audio story, queue a next story, show a next suggested story, etc. The selection of subsequent audio stories may be provided and selected based on prior audio stories, user preferences, artificial intelligence, etc.

As an example, an author can be a journalist. The journalist can create mini audio movies. The benefits of being told a story can include a greater retention of the information provided. Statistically, when told a story, accompanied with engaging music and text accompanied sound effects, the listener can retain more of the story. Journalists can provide the option for readers to be told an engaging story by providing the reader to have their articles read aloud and complimented by theatrical background music and text accompanied sound effects.

### Author Dashboard Overview

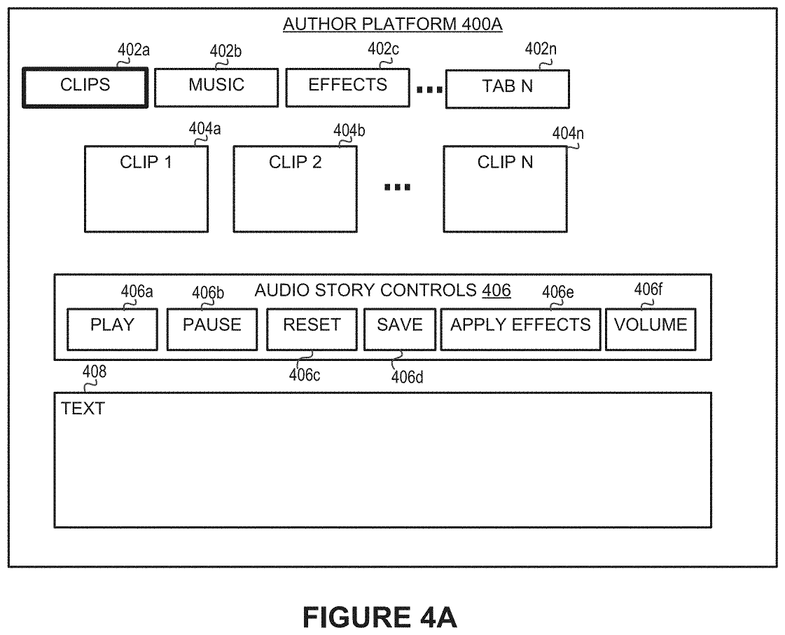

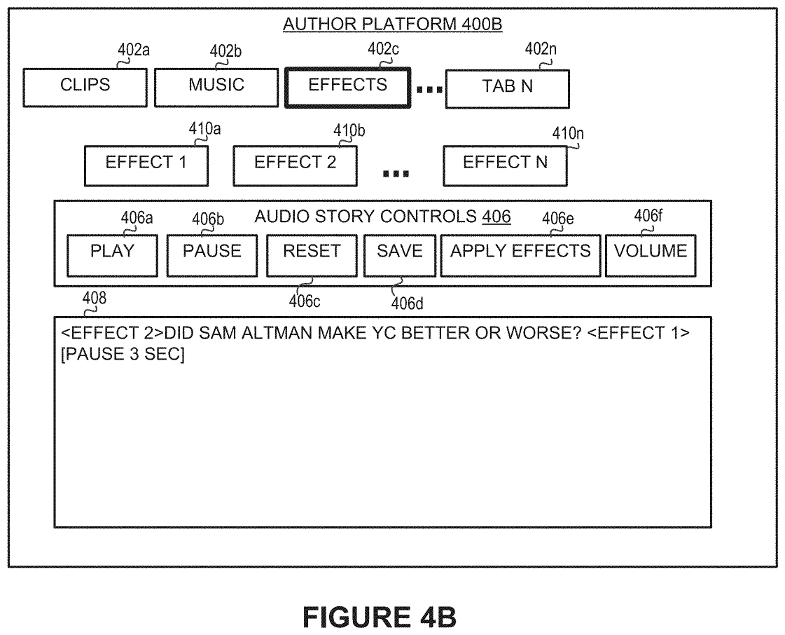

As noted above, an author or editor can modify an audio file to incorporate various features into an audio story. FIGS. 4A-4B illustrate example interfaces 400a, 400b for authoring or editing aspects of an audio story.

FIG. 4A illustrates a first example interface 400a for authoring or editing aspects of an audio story. As shown in FIG. 4A, the interface 400a includes a series of tabs 402a-n. Each tab 402a-n can allow for display of various content relating to each tab. For instance, the tabs can include a clips tab 402a, a music tab 402b, an effects tab 402c, and any other number of tabs 402n.

In the embodiment as shown in FIG. 4A, the clips tab 402a has been selected to identify a series of clips 404a-n. Each clip can include a predetermined sound effect that can be incorporated into the audio story. The user can search for any number of pre-stored clips, features, etc., using a search functionality.

The interface 400a, 400b can include audio story controls 406 capable of modifying the output of the audio story that can be utilized in editing or authoring an audio story. Example audio story controls 406 include a play icon 406a, a pause icon 406b, a reset icon 406c, a save icon 406d, an apply effects icon 406e, a volume icon 406f, etc. For example, if the play icon 406a is pressed, the audio can play and an associated word in the text 408 can highlight. The apply effects icon 406e can apply one or more effects (e.g., clips, music, effects) based on various inputs, such as a machine learning-driven adaption of past edits or edits made on a global scale, for example.

The text 408 can provide a view of the text that is converted into speech as part of the audio story. Each portion of text 408 corresponds to a part of the audio story such that each word can correlate to a timestamp of the audio story.

The interface 400a, 400b can include a webpage, desktop application, or mobile application that an author of the audio story may interact with. The author may provide information or credentials to log onto an author-specific profile storing information relating to the author. The author can register to create a profile associated with the author. The author can view projects in progress or completed and create a new project. An author can choose to edit or upload a project. The text file can be converted into audio via text to speech. The text to speech can include artificial intelligence. The article may be read aloud, word for word, either by the Articles author who records their voice or by a text to speech technique.

An author can select various buttons to add supplemental information at various times in the audio. For example, an emphasis can be added at a first part of the audio media, and a pause can be added at a second part of the audio media. Numerous effects can be added as supplemental information in the audio story to create a compelling and memorable audio story.

FIG. 4B illustrates a second example interface 400b for authoring or editing aspects of an audio story. As shown in FIG. 4B, the interface 400b includes an effects tab 402c displaying various effects 410a-n. Effects can include modifications to the output of the speech in an audio story, such as a pause effect, soften effect, emphasize effect, etc.

Effects can be added into the audio story on the interface 400b by selecting portions of the text in which to add the effect. For instance, a second effect can be added prior to a sentence in the text. This addition can update the audio story to include that effect at a time position corresponding to the selected part of the text. As another example, multiple effects can be included in the text, such as effect 1, effect 2, and a pause 3 sec. effect indicator.

Supplemental information (e.g., music, effects, video, visuals) can be added to portions of the audio to create the audio story. As an example, if the article relates to a battle, the author (or, alternatively, the system may dynamically identify and integrate) can add ominous background music coupled with the sound of gunfire or distant explosions to the audio story to provide a compelling and realistic experience for the user/listener/reader. The associated audio can be edited by clicking on a button representing a sound or clicking on an associated word. Sounds may be added (Any Sound) giving the user (listener) a realistic experience as if the user/listener experiencing the article as if they were there. The converted audio can highlight specific words to apply a music overlay to the associated audio.

### Generation of User-Specific Audio Stories

As noted above, an audio story is based on converting a text-based media into speech. One straightforward way to provide an audio version of text is to convert the text into speech. The speech may include a computer-generated voice or recorded speech of a voice actor. However, simply converting text into speech may inadequately capture compelling features of the text. For example, an uplifting news article simply converted into speech of a computer-generated voice may inadequately portray the uplifting portions of the uplifting news article. This may result in lower user experience and may lessen engagement with the media.

Accordingly, disclosed herein are embodiments relating to generating an audio story based on text-based media. Text media (e.g., a news article) can be converted into an audio media (e.g., speech). Further, the converted audio may be edited to include supplemental information, such as sound effects, music, video, etc. The converted audio and the supplemental information together may form the audio story. The audio story may include an increased user experience as well as higher user retention of the information conveyed in the audio story.

Further, as described in greater detail below, the audio story may be user-specific. For example, the audio story can include music, effects, etc. that are specifically tailored to characteristics relating to a user. Further, the present embodiments may relate to adding advertisements to the audio story that correspond to characteristics relating to both the user and the audio story.

As described in greater detail herein, user-specific audio story generation may include utilizing both internal and external characteristics in generating an audio story specific to a user. The user-specific audio story can have music and sounds personal to the user. In some embodiments, the information included in the audio story can be based on the user characteristics.

As noted above, audio stories include both converted text as well as additional media (e.g., music, effects). In some cases, the audio story may be uniform for a plurality of users receiving the audio story. However, in some instances, a user may obtain a user-specific audio story that is tailored to user characteristics and preferences.

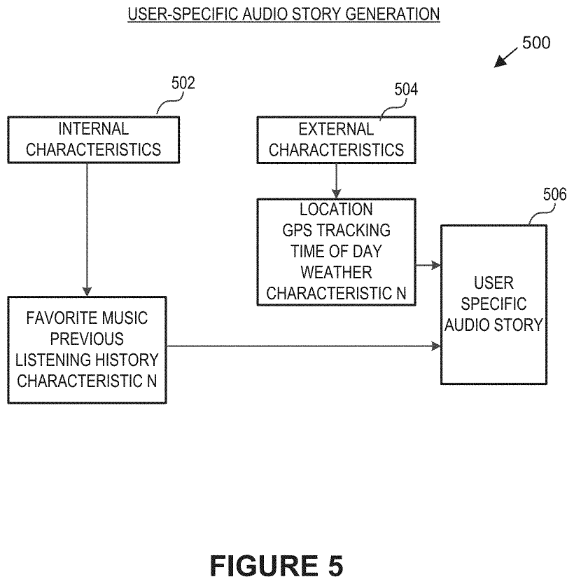

FIG. 5 is an example block diagram 500 for generating a user-specific audio story. As shown in FIG. 5, generation of a user-specific audio story can be based on both internal characteristics 502 and external characteristics 504. Internal characteristics 502 can include known information relating to the user. Example internal characteristics 502 can include favorite music of the user, previous listening history of the user, or any other number of characteristics.

External characteristics 504 can include features relating to the environment around the user. For example, external characteristics 504 can include a location of the client device, GPS tracking information, a time of the day, current weather, or any other number of characteristics.

As described in greater detail below, a combination of internal characteristics 502 and external characteristics 504 can be utilized in generation of the user-specific audio story 506.

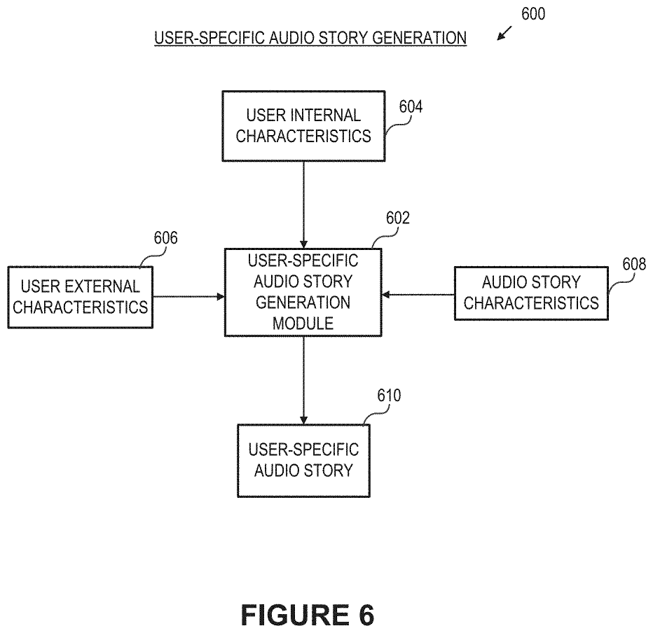

FIG. 6 is a block diagram 600 of an example illustration for generating a user-specific audio story. As shown in FIG. 6, a user-specific audio story generation module 602 may generate a user-specific audio story. The user-specific audio story generation module 602 may be executed on a computing device (e.g., server, computer) configured to generate a user-specific audio story.

As shown in FIG. 6, the user-specific audio story generation module 602 may generate a user-specific audio story based on user internal characteristics 604, user external characteristics 606, and audio story characteristics 608. In some embodiments, the user-specific audio story generation module 602 may utilize artificial intelligence, machine learning, neural networks, etc. to improve accuracy of the user-specific audio story.

User internal characteristics 604 can include known or identifiable characteristics of a user. For example, user internal characteristics can relate to a background, education, age, gender, work history, etc. of the user. Such information can weigh into the generation of the audio story, as various sounds, article types, etc. preferable to the user can be derived from the user internal characteristics. For example, a user's age may dictate a genre of music or a series of musical acts within a genre that they prefer.

In some embodiments, the user internal characteristics 604 can identify favorite song(s), genre(s), era(s) of music, etc. that are preferable to the user. This information may be obtained from a third-party source or by identifying music that the user has indicated a preference for. In some embodiments, identifying favorite music can include identifying whether the user likes or dislikes specific music, and updating the user internal characteristics according to the indication of whether the user likes that music.

In some embodiments, the user internal characteristics 604 may include an audio story history of the user. For example, each previous audio story selected by a user can be maintained and stored to be used in identifying subsequent audio stories for a user. The audio story history may indicate a length time the user was listening to an audio story or common themes among audio stories that the user listened to its entirety. From this information, user preferences may be identified.

For example, if a user listens to audio story with music of a first genre (e.g., Hip-Hop) for longer periods of time on average than audio stories with music of a second genre (e.g., Rock), indicating that the user may favor Hip-Hop over Rock music. As another example, if a user skips audio stories relating to politics, the user may not want future audio stories to relate to politics.

User external characteristics 606 can include objective characteristics about an environment around the user. For example, a user geographic location, region, weather, time of day, etc. can impact the resulting user-specific audio story. For example, identifying that a user's local time is Monday morning may result in a first genre of music (e.g., classical, calming music) being selected for a first audio story, while identifying that a user's local time is Friday evening may result in a different genre of music (e.g., upbeat/rhythmic music) being selected for an audio story.

Audio story characteristics 608 may include features parsed from the converted text that is included in the audio story. For example, the audio story can include speech converted from a news article and social media posts relating to the news article. The text may be parsed and processed to derive various features of the audio story. Example audio story characteristics may include an audio story type (e.g., comedy, investigative journalism), a tone, language used in the story, critical reception of the audio story text, a source website, the author, etc.

The user-specific audio story generation module 602 may obtain the user internal characteristics 604, user external characteristics 606, and/or audio story characteristics 608 and generate a user-specific audio story 610 based on weighing all factors included in the characteristics. For example, the user-specific audio story generation module may be configured to give specific weight to each factor included in the characteristics.

The user-specific audio story generation module 602 may output a user-specific audio story for a specific user. In some embodiments, the user-specific audio story generation module may obtain feedback information from the user after receiving the user-specific audio story. The feedback information may be fed into the user-specific audio story generation module and the user internal characteristics to further increase accuracy of subsequent audio stories.

In some embodiments, inputs for generation of a user-specific audio story can include text, images, video, etc., associated with a text-based media or the client. The system can extract specific sounds to link or text, localization content (e.g., GPS data) to identify a geographic location (e.g., region, city, coast) of the client, and/or emotional content information from the input information for use in generation of an audio story. The output in the audio story can include audio (e.g., ambient sounds) that are appropriate to the localization content associated with the user. For example, if the geographic location of the client indicates that the client is near an ocean (e.g., at the beach, in a city associated with a beach), the audio story can include ambient sounds indicative of the ocean (e.g., sounds of waves crashing).

In some instances, the ambient sounds can be indicative of a region depicted/represented in an audio story. For example, if the text-based media is discussing a surfing competition on an island, the ambient sounds included in the audio story can be indicative of the ocean (e.g., waves crashing, island music).

In some instances, the output in the audio story can be appropriate to the emotional content detected. For instance, a content model can be generated that can be utilized in deriving emotional content of a text-based media. The derived emotional content can be used to derive audio sounds that correspond to the emotion of the text-based media.

In some embodiments, the output of in the audio story can include background sounds appropriate to specific elements. For example, background sound effects from text recognition can be added to the audio story, such as launch sounds of a rocket based on word recognition and/or image recognition determining that the text-based media relates to a rocket launch.

### Addition of Other Text-Based Media in an Audio Story

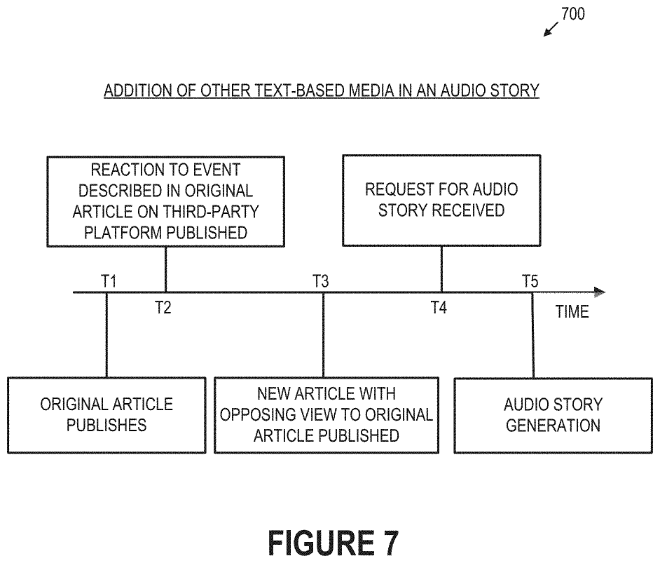

As noted above, the audio story can include information retrieved from multiple sources. FIG. 7 is a block diagram 700 of an example timeline for addition of text media to an audio story. As noted above, the audio story can include speech that is converted from text. The audio story can include text retrieved from various sources. For example, an audio story can include a combination of a news article and social media posts generated in response to the news article. Various elements from the text retrieved from multiple sources can be parsed and combined to comprise the audio story.

As shown in FIG. 7, the original article is generated/published a first time T1. For example, the original article can describe a major event by a corporation.

At a second time T2, a reaction to the event described in the original article may be posted on a third-party platform (e.g., social network, news site, official comment to the event). For example, an executive of the corporation may post a comment on social media. The reaction can be parsed and processed to determine whether the reaction should be included in the audio story. For example, a level of criticism or a number of shares of the reaction can be inspected to determine whether the reaction should be included in the audio story.

Another article by a separate author with an opposing view may be published at a third time T3. The audio story can capture both the views of the author in the original article as well as an opposing view posited in the new article. For example, if the original article implies that the event described in the article will have a negative effect to the corporation over time, the view article can posit that the event will actually have a positive effect for the corporation over time.

At a fourth time T4, a request for generation of an audio story can be received. This can include detecting a selection of an audio story generation icon, for example.

At a fifth time T5, the audio story can be generated. The audio story can include various text-based media sources. Various elements of multiple sources of text may be combined to generate the audio story. For example, a reaction to the event posted on social media may be added into the text of the original article. Further, transition phrase or an introduction to the added text may be added to the audio story. The audio story can be updated dynamically to include new information as new information becomes available.

As noted below, the content in the audio story can be utilized in identifying subsequent audio stories to present to the user. For example, after outputting a first audio story, a second audio story can be provided to the user that is by a similar author or includes a similar topic being discussed. In some embodiments, a series of audio stories may be provided to a user in a playlist.

### Author Onboarding Overview

Author onboarding may include a process to connect an author to a system as described herein. Author onboarding may include registering an author, identifying details or a persona of the author, identifying all articles by the author, identifying an article score or author score, and generating an author dashboard.

The present embodiments may relate to addition or onboarding of an author to the system as described herein. An author (i.e. one who contributed to creation of a text-based work) may generate a profile on the platform to generate audio stories of past and future text-based works. In some embodiments, the process as discussed below may be performed for a representative of an author, a publisher, a news aggregator, a website, an agent for the author, etc.

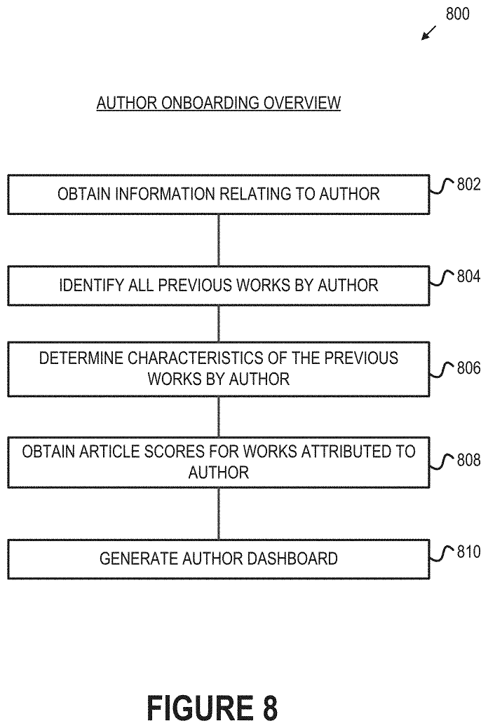

An author may be added or onboarded onto a platform to convert an article into an audio story. FIG. 8 is an example flow process 800 for onboarding an author. The process can include obtaining information relating to an author (block 802). The obtained information can include a background, personal information, credentials, education, work history, etc. relating to the author.

In some embodiments, the obtained information for the author may include identifying a particular expertise or persona of the author. For example, an expertise or persona can relate to a topic of interest for the author or an article type of choice (e.g., comedic writer, investigative journalism, sports journalism) by the author.

The process can include identifying all previous works by author (block 804). This can include inspecting various internet sources for publications attributed to the author. For example, a web crawling process may inspect third-party platforms to identify articles attributed to the author. In some embodiments, this may include retrieving social media posts or blog posts from the author.

The works can be parsed and inspected to derive characteristics of the works (block 806). Example characteristics that can be derived may include tone, expertise, language used, reception to articles, type of article, accuracy in statements, etc.

The information about the author and the article characteristics can be used to generate a persona of the author. The persona derived for an author can be represented by keywords or descriptive identifiers. The descriptive identifiers can be used to identify a type of work commonly created by the author, for example. The descriptive identifiers can also be used to identify authors with similar qualities or characteristics.

The process may include deriving an article score for the works created by the author (block 808). A score for an article may be indicative of quality or reception of an article. For example, a critical reception of the article or a number of shares of the article can impact the score. The score may also be based on any number of other suitable factors, such as grammatical accuracy, for example. A score can be locally generated or by third-party.

Scores can be aggregated for an author to provide an author score indicative of an overall article score for an author. The article score or author score, in addition to the descriptive identifiers of the author, can be used in recommending an article or author to a user.

The process can include generating a dashboard for the author (block 810). The dashboard can include various information relating to the author, such as article scores, descriptive identifiers for the author, a listing of previous articles, etc. The dashboard can provide an audio story generation tool to generate an article and an associated audio story. The dashboard can allow for an author to share, collaborate, store, and modify audio stories and other information. For example, the dashboard can allow an author to perform research for an article, collaborate with other authors on a topic, generate an article, and publish an audio story based on the article.

### User-Specific Audio Story Advertisement Generation

In some embodiments, a user-specific audio story with advertisements may be generated. User information can be utilized to modify the music and sounds to be included in an audio story. Further, various information may be used to generate local advertisement that correspond to the user and to the audio story being generated. Accordingly, the audio story can include an article, an advertisement, music, sounds, and speech.

In many cases, advertisements for various media (e.g., television, radio) are designed to be universal to all viewers of the media. For example, an insurance corporation may provide a television advertisement of insurance services to all viewers of a television program.

However, in many cases, these universal advertisements may be unrelated to many viewers of the media. For example, the advertiser may be outside of a geographic region of the user or provide a service unrelated to the user.

Accordingly, in some embodiments, the audio story may include user-specific advertisements embedded into the audio story that correspond to both the audio story characteristics and user characteristics. For example, an audio story may include speech representing an advertisement included within speech of a news article. The additional media (e.g., music) can be similar during the entirety of the audio story, which may increase user experience when listening to the audio story that includes advertisements.

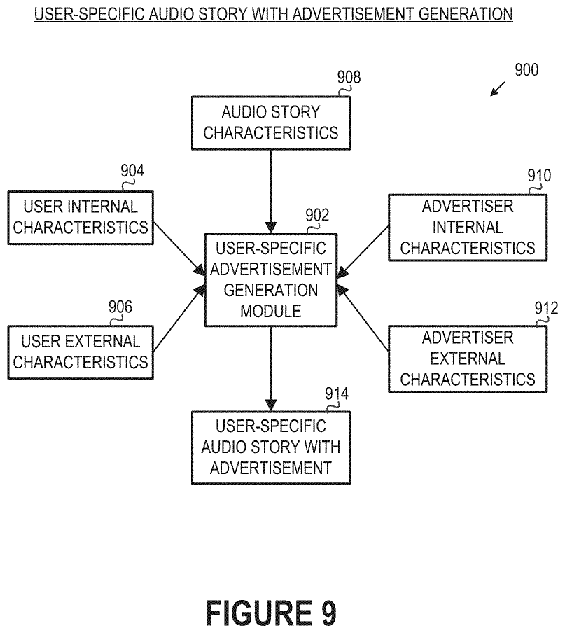

FIG. 9 is a block diagram 900 of an example illustration for generating a user-specific audio story with user-specific advertisements. As shown in FIG. 9, generating a user-specific audio story with user-specific advertisements may include inspecting information from various sources by a user-specific advertisement generation module 902. The user-specific advertisement generation module 902 may utilize a combination of user internal characteristics 904, user external characteristics 906, audio story characteristics 908, advertiser internal characteristics 910, and/or advertiser external characteristics 912 to generate a user-specific audio story 914 with user-specific advertisements.

The user-related characteristics, audio story characteristics, and advertiser-related characteristics may be weighed and combined to identify an advertisement that relates to the user and matches the qualities of the audio story. In some cases, a plurality of advertisements from a series of advertisers may be inspected to determine an advertisement to add to the audio story.

For example, the advertisement can correspond to user-related characteristics. This can include identifying potential advertisements that correspond to user needs and interests. The advertisement may also correspond to user external characteristics, such as a geographic region of the user. This may increase user engagement with the advertisement and increase the quality of the user experience with the audio story.

The advertisement can also correspond with the audio story characteristics. For example, the advertisement can have qualities that match those of the audio story.

The user-specific advertisement generation module 902 may utilize advertiser internal characteristics in identifying an advertisement to include into a user-specific audio story. Advertiser internal characteristics may include various features or aspects of the advertisement to be included in an audio story. Example advertiser internal characteristics may include a tone, language used, type of advertisement (e.g., humorous, informative), etc. identified from the advertisement. The advertisement may be parsed and processed to derive the advertiser internal characteristics.

The user-specific advertisement generation module may also utilize advertiser external characteristics in identifying an advertisement to include into a user-specific audio story. Advertiser external characteristics may include objective qualities of an advertiser. Example advertiser internal characteristics may include a region that the advertiser operates, the services that the advertiser provides, what primary groups of individuals does the advertiser generally provide services, etc.

Upon determining an advertisement to include into the audio story, the user-specific advertisement generation module may add the advertisement into the audio story. This can include identifying a position in the output of the audio story to add the advertisement so as to minimize disruption of the flow of the audio story. Transition language may be added to the audio story such that the audio story transitions between the audio story speech and the advertisement speech. Similar effects and music may continue between the audio story and advertisement.

In some embodiments, a first client can include a listener/user of the system. A second client can include an advertiser (e.g., advertising firm, agency, brand, etc.). The second client can provide various information to the system relating to advertising content. For instance, the second client can provide their own advertising content that can be integrated into audio stories. The second client can also provide their own audio stories that can be incorporated into a playlist of audio stories provided to the first client. The advertiser's audio stories can be tailored/personalized to the first client based on characteristics of the first client. Personalization of audio stories can incorporate artificial intelligence, machine learning, deep learning, etc.

The algorithmic inputs can assist to create continuity of an audio story that incorporates advertising content. For example, personalized advertising content can be curated specific to the user using various algorithms. The algorithms can calculate a first client's preset variables and/or calculate new ongoing variables associated with the first client. The algorithms (e.g., artificial intelligence, machine learning, deep learning) can derive best guess variables based on unknown or limited information relating to the client.

If there is no information relating to the client, a random advertisement or an advertisement corresponding to content of the audio story can be provided. In some instances, a client profile (e.g., internet history (or “cookie”)) of a client can be used to identify advertiser content that matches the client profile. The client may prevent collection/cultivation of information to be utilized for audio story generation, resulting in a targeted audio story/advertising experience.

The output of an audio story with advertising content can include a similar sound construct as the rest of the audio story that is tailored to client information based on the same variables or a combination of settings chosen by the advertiser.

In some instances, advertising can be based on key word, references, and/or targeted placement not related to key words, advertisers may place a sound byte(s) within the audio story. As an example, if a corporation (e.g., Twitter®) is mentioned or not mentioned, an associated sound (e.g., a “tweet” sound) can be input into the audio story as a direct or indirect notification. This can be used as a reference for a client to take an action based on the advertisement sound byte. Audio associated with a brand (or “brand audio”) can be provided in advertising content in an audio story.

### Output of an Audio Story

An audio story may be output to a user device upon identifying an indication by a user to output an audio story. This may include receiving an indication from a user device requesting an audio story based on a news article, for example. In some embodiments, the audio story can be distributed among a plurality of users.

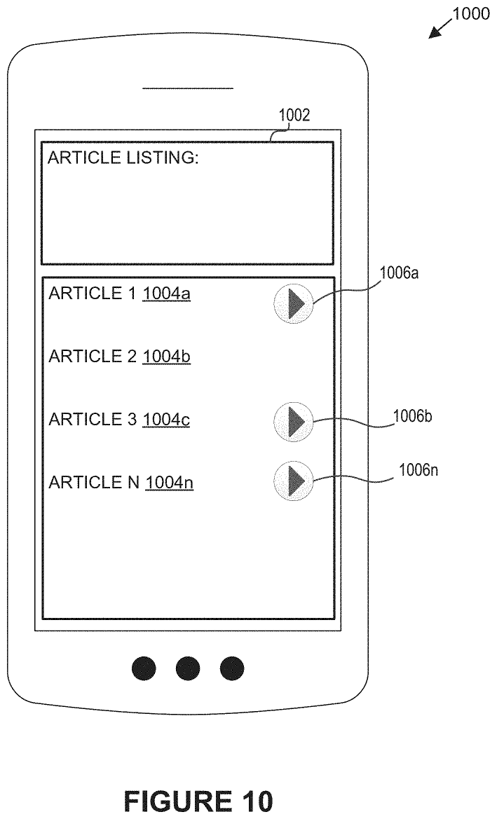

FIG. 10 is an example interface 1000 illustrating a series of articles with icons to output an audio story. As shown in FIG. 10, an article listing 1002 can include a series of articles 1004a-n. For example, the listing of articles 1002, a first article 1004a can include a first icon 1006a, a second article 1004b may not include an icon, a third article 1004c can include an icon 1006b, and any number of articles (e.g., article N 1004n) can include any number of icons (e.g., icon n 1006n). Selecting of an icon 1006a-n can initiate generation and output of an audio story as described herein.

A news source (e.g., a news aggregator) can include any online platform configured to display multiple news articles or publications relating to multiple articles. The news source can include a play button that is configured to instruct the system to generate an audio story of the article upon selecting the play button. In some embodiments, an audio story can be generated upon selection of the play button. In other embodiments, a portion of the audio story can be generated prior to the selection of the play button while the rest of the audio story can be generated after the selection of the play button.

As an example, prior to receiving an indication to play an audio story, the content of the audio story can be determined, and text can be converted into speech. In this example, after selection of the indication by a user, the music and sounds can be added based on user characteristics. Additionally, after selection of the indication by a user, an advertisement can be added to the audio story. Any of the processing steps as described herein can be performed either prior to receipt of an indication to play an audio story by a user or after reception of an indication to play the audio story.

### Example Method for Generation of an Audio Story

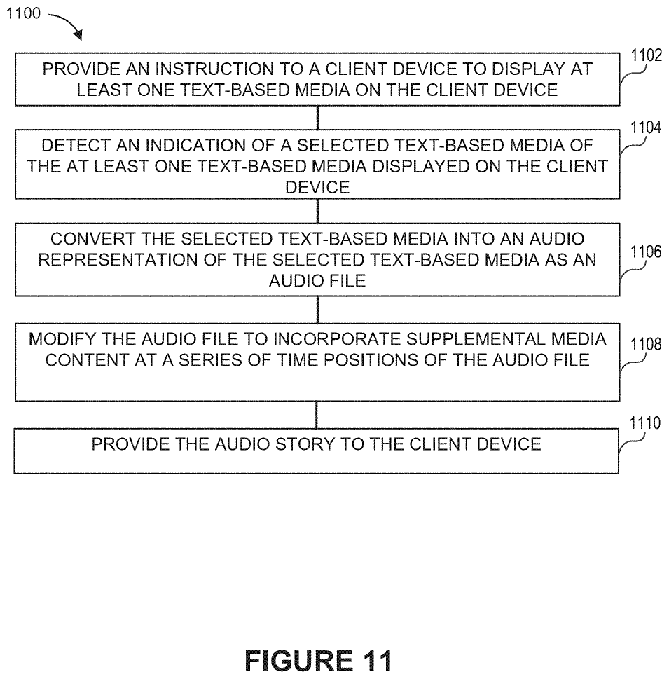

FIG. 11 is a block diagram of an example method 1100 for generating an audio story. The method may include providing an instruction to a client device to display at least one text-based media on the client device (block 1102). For example, an application executing on a client device can display a series of news articles for the client to select.

In some embodiments, the instruction to the client device to display the at least one text-based media on the client device includes a news aggregation webpage displaying a series of text-based news articles, wherein the selected text-based media includes a first news article.

The method may include detecting an indication of a selected text-based media of the at least one text-based media displayed on the client device (block 1104). The selected text-based media can be utilized in generation of an audio story.

In some embodiments, detecting the indication of the selected text-based media of the at least one text-based media displayed on the client device includes the client device determining that an icon associated with the selected text-based media has been selected on the client device.

The method may include converting the selected text-based media into an audio representation of the selected text-based media as an audio file (block 1106). A time position of each portion of the audio file can correspond to a portion of the selected text-based media.

In some embodiments, an authoring dashboard can be used to generate/edit/publish audio stories. The method may include providing an instruction to implement an authoring dashboard on an author device, the authoring dashboard incorporating the audio file. The method may also include modifying the audio file based on a series of supplemental audio effects added at various time positions of the selected text-based media in the authoring dashboard.

In some embodiment, the method includes subsequent to generation of the audio file, identifying a second text-based media that was published in response to the selected text-based media. The method may also include converting the second text-based media into an audio representation of the second text-based media by comparing each word of the second text-based media with a corresponding entry in a listing of speech entries. The method may also include modifying the audio file to incorporate the audio representation of the second text-based media into the audio file.

In some embodiments, the authoring dashboard causes display of the selected text-based media and allows for an author to add the series supplemented audio effects into the various time positions of the selected text-based media.

The method may include modifying the audio file to incorporate supplemental media content at a series of time positions of the audio file (block 1108). The supplemental media content can differ from that of the audio representation of the selected text-based media. The modified audio file may comprise the audio story.

In some embodiments, modifying the audio file to incorporate supplemental media content at the series of time positions of the audio includes inspecting words included in the selected text-based media to generate a content model representing features of the selected text-based media. The content model can be generated using various techniques (e.g., pattern recognition, artificial intelligence, neural networks) that can be utilized in accurately deriving supplemental information that corresponds with a type of content depicted in the selected text-based media. The content model can be processed to derive a predicted emotion of the selected text-based media. The derived predicted emotion can be compared with a listing of known supplemental audio types to identify a first supplemental audio type that corresponds to the derived predicted emotion of the selected text-based media. At a series of time positions throughout a duration of the selected-text based media, the audio story can be modified to add a supplemental audio effect included in the first supplemental audio type.

In some embodiments, a series of internal characteristics and a series of external characteristics relating to the client can be identified, where the series of internal characteristics can be indicative of past interactions by the client and the series of external characteristics can be indicative of environmental features detected by the client device. A prediction model can be generated based on the identified series of internal characteristics and the series of external characteristics relating to the client. The prediction model can include a model constructed using various techniques that can predict desired supplemental content to be provided to a specific client. The prediction model can be processed to derive a set of features that are associated with the client. A second supplemental audio type of the listing of known supplemental audio types can be identified that corresponds to the set of features associated with the client. At a series of time positions throughout a duration of the selected-text based media, the audio story can be modified to add a supplemental audio effect included in the second supplemental audio type.

In some embodiments, modifying the audio file to incorporate supplemental media content at the series of time positions of the audio file further comprises inspecting words included in the selected text-based media to identify a series of keywords in the selected text-based media. The series of keywords can be compared to derive a nature of the selected text-based media. The derived nature of the selected text-based media can be compared with a listing of known supplemental audio types to identify a first supplemental audio type that corresponds to the derived nature of the selected text-based media. At a time position corresponding with each of the identified series of keywords, the audio story can be modified to add a supplemental audio effect included in the first supplemental audio type.

In some embodiment, the method can include processing the content model of the selected text-based media to derive a geographic profile indicative of a primary geographic region identified in the selected text-based media. The geographic profile can be compared with the listing of known supplemental audio types to identify a third supplemental audio type that corresponds to the geographic profile. At the series of time positions throughout the duration of the selected-text based media, the audio story can be modified to add a supplemental audio effect included in the third supplemental audio type. As an illustrative example, if a text-based media is an article about a surfing competition, the geographic profile can be indicative of a beach or region (e.g., Hawaii) where the beach is located. In this example, the system can provide supplemental audio (e.g., sounds) that corresponds to the beach (e.g., waves crashing, local music).

In some embodiments, a geographic region indicator can be detected indicative of a geographic location of the network-accessible device. The geographic region indicator can be compared with the listing of advertising content entries to identify a first audio content entry that includes audio content that corresponds to the geographic location of the network-accessible device. The audio story can be modified to add the audio content included in the first audio content entry to the audio story.

In some embodiment, subsequent to generation of the audio file, a quote provided in a second text-based media provided in response to the selected text-based media can be identified. The second text-based media can be converted into an audio representation of the second text-based media by comparing each word of the second text-based media with a corresponding entry in a listing of speech entries, wherein the audio representation of the second text-based media includes a voice type that is different than a voice type of the audio representation of the selected text-based media. The voice type can be provided by a voice actor or computationally derived from the system. The audio file can be modified to incorporate the audio representation of the second text-based media into the audio file.

In some embodiments, the method includes identifying a series of internal characteristics and a series of external characteristics relating to the client. The series of internal characteristics can be indicative of past interactions by the client and the series of external characteristics can be indicative of environmental features detected by the client device. The method can include comparing the derived nature of the selected text-based media with the series of internal characteristics and the series of external characteristics relating to the client with the listing of known supplemental audio types to identify a second supplemental audio type that corresponds to the series of internal characteristics and the series of external characteristics relating to the client. The method can also include, at each time position corresponding with each of the identified series of keywords, modifying the audio story to add a supplemental audio effect included in the second supplemental audio type.

In some embodiments, the method includes retrieving a listing of advertising content entries, each advertising content entry including characteristics relating to advertising content. The method may include comparing the derived nature of the selected text-based media with the listing of advertising content entries to identify a first advertising content entry that corresponds to the derived nature of the selected text-based media. The method may also include modifying the audio story to add the first advertising content entry to the audio story.

In some embodiment, the method includes identifying a series of internal characteristics and a series of external characteristics relating to the client, the series of internal characteristics indicative of past interactions by the client, the series of external characteristics indicative of environmental features detected by the client device. The method may also include comparing the series of internal characteristics and the series of external characteristics relating to the client with the listing of advertising content entries to identify a second advertising content entry that corresponds to the series of internal characteristics and the series of external characteristics relating to the client. The method may also include modifying the audio story to add the second advertising content entry to the audio story.

The method may include providing the audio story to the client device (block 1110). The client device can be configured to playback the audio story responsive to identifying an indication to playback the audio story.

In some embodiments, the client device is configured to, at each time position of the audio story, highlight each corresponding portion of the selected text-based media on a display of the client device.

In some embodiments, an icon can highlight text on the display that corresponds to the speech playing back in the audio story. For example, at a first time, an icon may be displayed that highlights a first word of the selected text-based media that corresponds to a first portion of the audio story at the first time. Then, at a second time, a position of the icon on the display can be updated to highlight a second word of the selected text-based media that corresponds to a second portion of the audio story at the first time.

In some embodiment, the audio story can be generated specific to a user. For example, the method can include detecting a second indication of the selected text-based media of the series of text-based media by a second client. A second series of characteristics can be obtained relating to the second client. The series of keywords and the second series of characteristics can be compared with the listing of known supplemental audio types to identify a second supplemental audio type that corresponds to the series of keywords and the second series of characteristics. The audio file can be modified to add supplemental audio effects included in the second supplemental audio type at time positions corresponding with each of the identified series of keywords, the modified audio file comprising the audio story.

In some embodiments, an author can be onboarded to gain access to an authoring dashboard. The authoring dashboard can allow for an author to create/edit/publish/etc. text-based media and/or audio stories.

In some embodiments, the method may include detecting an indication to initiate an onboarding process for an author. The onboarding process may include retrieving a set of previously published text-based media associated with the author and critical responses associated with the previously published text-based media. The onboarding process may also include parsing information included in the previously published text-based media and the critical responses to identify a series of persona characteristics indicative of a persona of the author. The onboarding process may also include generating an author score based on the series of persona characteristics, the author score indicative of a critical reception and a quality of the previously published text-based media associated with the author. The onboarding process may also include granting the author access to an authoring dashboard capable of any of creating, editing, and publishing text-based media and audio stories.

In some embodiments, the author score can be used to match a client to works by an author. For instance, the author score can be processed to determine whether the author score is within a threshold similarity to a series of characteristics corresponding to the client. Responsive to determining that the author score is within the threshold similarity to the series of characteristics corresponding to the client, a text-based media relating to the author can be presented on the display of the series of text-based media, wherein the selected text-based media includes the text-based media relating to the author.

### Processing System

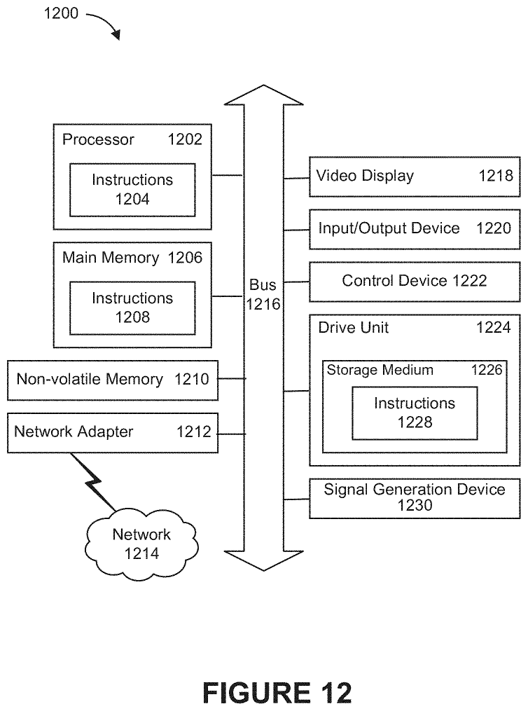

FIG. 12 is a block diagram illustrating an example of a processing system in which at least some operations described herein can be implemented. For example, some components of the processing system 1200 can be hosted on an electronic device as described in the present embodiments.

The processing system 1200 can include one or more central processing units (“processors”) 1202, main memory 1206, non-volatile memory 1210, network adapter 1212 (e.g., network interface), video display 1218, input/output devices 1220, control device 1222 (e.g., keyboard and pointing devices), drive unit 1224 including a storage medium 1226, and signal generation device 1230 that are communicatively connected to a bus 1216. The bus 1216 is illustrated as an abstraction that represents one or more physical buses and/or point-to-point connections that are connected by appropriate bridges, adapters, or controllers. The bus 1216, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (i.e., “Firewire”).

The processing system 1200 can share a similar computer processor architecture as that of a desktop computer, tablet computer, personal digital assistant (PDA), smartphone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1200.

While the main memory 1206, non-volatile memory 1210, and storage medium 1226 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1228. The term “machine-readable medium” and “storage medium” shall also be taken to include any medium that is capable of storing, encoding, or carrying a set of instructions for execution by the processing system 1200.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in a computing device. When read and executed by the one or more processors 1202, the instruction(s) cause the processing system 1200 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1210, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1212 enables the processing system 1200 to mediate data in a network 1214 with an entity that is external to the processing system 1200 through any communication protocol supported by the processing system 1200 and the external entity. The network adapter 1212 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1212 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Conclusion

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium can include recordable/non-recordable media (e.g., read-only memory (ROM), random access memory (RAM), magnetic disk storage media, optical storage media, flash memory devices, etc.).

Any of the steps as described in any methods or flow processes herein can be performed in any order to the extent the steps in the methods or flow processes remain logical.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

What is claimed is:

1. A computer-implemented method for generating an audio story, the method comprising:
detecting an indication of a selected text-based media of \ at least one text-based media displayed on a client device, wherein the selected text-based media is to be utilized in generation of an audio story;
converting the selected text-based media into an audio representation of the selected text-based media as an audio file, wherein a time position of each portion of the audio file corresponds to a portion of the selected text-based media;
modifying the audio file to incorporate supplemental media content at a series of time positions of the audio file, the supplemental media content differing from that of the audio representation of the selected text-based media, the modified audio file comprising the audio story; and
providing the audio story to the client device, wherein the client device is configured to playback the audio story responsive to identifying an indication to playback the audio story.

2. The computer-implemented method of claim 1, wherein said modifying the audio file to incorporate supplemental media content at the series of time positions of the audio file further comprises:
inspecting words included in the selected text-based media to generate a content model representing features of the selected text-based media;
processing the content model to derive a predicted emotion of the selected text-based media;
comparing the derived predicted emotion with a listing of known supplemental audio types to identify a first supplemental audio type that corresponds to the derived predicted emotion of the selected text-based media; and
at a series of time positions throughout a duration of the selected-text based media, modifying the audio story to add a supplemental audio effect included in the first supplemental audio type.

3. The computer-implemented method of claim 2, further comprising:
identifying a series of internal characteristics and a series of external characteristics relating to the client, the series of internal characteristics indicative of past interactions by the client, the series of external characteristics indicative of environmental features detected by the client device;
generating a prediction model based on the identified series of internal characteristics and the series of external characteristics relating to the client;
processing the prediction model to derive a set of features that are associated with the client;
identifying a second supplemental audio type of the listing of known supplemental audio types that corresponds to the set of features associated with the client; and
at a series of time positions throughout a duration of the selected-text based media, modifying the audio story to add a supplemental audio effect included in the second supplemental audio type.

4. The computer-implemented method of claim 2, further comprising:
retrieving a listing of advertising content entries, each advertising content entry including characteristics relating to advertising content;
comparing the derived predicted emotion of the selected text-based media with the listing of advertising content entries to identify a first advertising content entry that corresponds to the derived predicted emotion of the selected text-based media; and
modifying the audio story to add the first advertising content entry to the audio story.

5. The computer-implemented method of claim 4, further comprising:
identifying a series of internal characteristics and a series of external characteristics relating to the client, the series of internal characteristics indicative of past interactions by the client, the series of external characteristics indicative of environmental features detected by the client device;
comparing the series of internal characteristics and the series of external characteristics relating to the client with the listing of advertising content entries to identify a second advertising content entry that corresponds to the series of internal characteristics and the series of external characteristics relating to the client; and
modifying the audio story to add the second advertising content entry to the audio story.

6. The computer-implemented method of claim 1, further comprising:
providing an instruction to implement an authoring dashboard on an author device, the authoring dashboard incorporating the audio file; and
modifying the audio file based on a series of supplemental audio effects added at various time positions of the selected text-based media in the authoring dashboard.

7. The computer-implemented method of claim 2, further comprising:
processing the content model of the selected text-based media to derive a geographic profile indicative of a primary geographic region identified in the selected text-based media;
comparing the geographic profile with the listing of known supplemental audio types to identify a third supplemental audio type that corresponds to the geographic profile; and
at the series of time positions throughout the duration of the selected-text based media, modifying the audio story to add a supplemental audio effect included in the third supplemental audio type.

8. The computer-implemented method of claim 1, further comprising:
subsequent to generation of the audio file, identifying a second text-based media that was published in response to the selected text-based media;
converting the second text-based media into an audio representation of the second text-based media by comparing each word of the second text-based media with a corresponding entry in a listing of speech entries; and
modifying the audio file to incorporate the audio representation of the second text-based media into the audio file.

9. A method performed by a network-accessible device for generating a audio story that is specific to a first client, the method comprising:
causing display of a series of text-based media;
detecting an indication of a selected text-based media of the series of text-based media, wherein the selected text-based media is to be utilized in generation of an audio story;
generating an audio representation of the selected text-based media as an audio file, wherein a time position of each portion of the audio file corresponds to a portion of the selected text-based media;
retrieving a first series of characteristics relating to the first client;
inspecting text included in the selected text-based media to identify a series of keywords in the selected text-based media;
comparing the series of keywords and the first series of characteristics relating to the first client with a listing of known supplemental audio types to identify a first supplemental audio type that corresponds to the series of keywords and the first series of characteristics relating to the first client;
modifying the audio file to add supplemental audio effects included in the first supplemental audio type at time positions corresponding with each of the identified series of keywords, the modified audio file comprising the audio story; and
causing playback of the audio story responsive to identifying an indication to playback the audio story.

10. The method of claim 9, wherein the first series of characteristics include a series of internal characteristics and a series of external characteristics relating to the first client, the series of internal characteristics indicative of past interactions by the first client, the series of external characteristics indicative of environmental features detected by the network-accessible device.

11. The method of claim 9, further comprising:
retrieving a listing of advertising content entries, each advertising content entry including characteristics relating to advertising content;
comparing the series of keywords with the listing of advertising content entries to identify a first advertising content entry that corresponds to the series of keywords; and
modifying the audio story to add the first advertising content entry to the audio story.

12. The method of claim 9, further comprising:
detecting a geographic region indicator indicative of a geographic location of the network-accessible device;
comparing the geographic region indicator with the listing of advertising content entries to identify a first audio content entry that includes audio content that corresponds to the geographic location of the network-accessible device; and
modifying the audio story to add the audio content included in the first audio content entry to the audio story.

13. The method of claim 9, further comprising:
subsequent to generation of the audio file, identifying a quote provided in a second text-based media provided in response to the selected text-based media;
converting the second text-based media into an audio representation of the second text-based media by comparing each word of the second text-based media with a corresponding entry in a listing of speech entries, wherein the audio representation of the second text-based media includes a voice type that is different than a voice type of the audio representation of the selected text-based media; and
modifying the audio file to incorporate the audio representation of the second text-based media into the audio file.

14. The method of claim 9, further comprising:
detecting a second indication of the selected text-based media of the series of text-based media by a second client;
retrieving a second series of characteristics relating to the second client;
comparing the selected text-based media and the second series of characteristics with the listing of known supplemental audio types to identify a second supplemental audio type that corresponds to the selected text-based media and the second series of characteristics; and
modifying the audio file to add supplemental audio effects included in the second supplemental audio type at a series of time positions of the selected text-based media, the modified audio file comprising the audio story.

15. The method of claim 9, further comprising:
detecting an indication to initiate an onboarding process for an author, the onboarding process including:
retrieving a set of previously published text-based media associated with the author and critical responses associated with the previously published text-based media;
parsing information included in the previously published text-based media and the critical responses to identify a series of persona characteristics indicative of a persona of the author;
generating an author score based on the series of persona characteristics, the author score indicative of a critical reception and a quality of the previously published text-based media associated with the author; and
granting the author access to an authoring dashboard capable of any of creating, editing, and publishing text-based media and audio stories.

16. The method of claim 15, further comprising:
processing the author score to determine whether the author score is within a threshold similarity to a series of characteristics corresponding to the client;
responsive to determining that the author score is within the threshold similarity to the series of characteristics corresponding to the client, presenting a text-based media relating to the author on the display of the series of text-based media, wherein the selected text-based media includes the text-based media relating to the author.

17. A tangible, non-transient computer-readable medium having instructions stored thereon that, when executed by a processor, cause the processor to:
detect an indication of a selected text-based media of at least one text-based media, wherein the selected text-based media is to be utilized in generation of an audio story;
convert the selected text-based media into an audio representation of the selected text-based media as an audio file, wherein a time position of each portion of the audio file corresponds to a portion of the selected text-based media;
modify the audio file to incorporate supplemental media content at a series of time positions of the audio file, the supplemental media content differing from that of the audio representation of the selected text-based media, the modified audio file comprising the audio story; and
playback the audio story responsive to identifying an indication to playback the audio story.

18. The computer-readable medium of claim 17, wherein said modify the audio file to incorporate supplemental media content at the series of time positions of the audio file further comprises:
inspect words included in the selected text-based media to identify a series of keywords in the selected text-based media;
compare the series of keywords to derive a nature of the selected text-based media;
compare the derived nature of the selected text-based media with a listing of known supplemental audio types to identify a first supplemental audio type that corresponds to the derived nature of the selected text-based media; and
at a time position corresponding with each of the identified series of keywords, modify the audio story to add a supplemental audio effect included in the first supplemental audio type.

19. The computer-readable medium of claim 17, further causing the processor to:
identify a series of internal characteristics and a series of external characteristics relating to the client, the series of internal characteristics indicative of past interactions by the client, the series of external characteristics indicative of environmental features detected by the client device;
compare the derived nature of the selected text-based media with the series of internal characteristics and the series of external characteristics relating to the client with the listing of known supplemental audio types to identify a second supplemental audio type that corresponds to the series of internal characteristics and the series of external characteristics relating to the client; and
at each time position corresponding with each of the identified series of keywords, modify the audio story to add a supplemental audio effect included in the second supplemental audio type.

20. The computer-readable medium of claim 17, further causing the processor to:
retrieve a listing of advertising content entries, each advertising content entry including characteristics relating to advertising content;
identify a series of internal characteristics and a series of external characteristics relating to the client, the series of internal characteristics indicative of past interactions by the client, the series of external characteristics indicative of environmental features detected by the client device;
compare the series of internal characteristics and the series of external characteristics relating to the client with the listing of advertising content entries to identify a first advertising content entry that corresponds to the series of internal characteristics and the series of external characteristics relating to the client; and
modify the audio story to add the first advertising content entry to the audio story.
